(19) United States
(12) Patent Application Publication
(10) Pub. No.: US 2025/0086194 A1
(43) Pub. Date: Mar. 13, 2025

(54) DATA PROCESSING METHOD, ELECTRONIC DEVICE, AND STORAGE MEDIUM

(71) Applicant: SHENZHEN ZOLON TECHNOLOGY CO., LTD., Shenzhen (CN)

(72) Inventor: JIANRONG ZHANG, Shenzhen (CN)

(21) Appl. No.: 18/723,476

(22) PCT Filed: Oct. 18, 2022
(86) PCT No.: PCT/CN2022/125978

§ 371 Date: Jun. 24, 2024

(30) Foreign Application Priority Data
Dec. 30, 2021 (CN) 202111656683.2

(51) Int. Cl. G06F 16/25; G06Q 20/20

(52) U.S. Cl. CPC G06F 16/258; G06Q 20/202

(57) ABSTRACT

The present application provides a data processing method. The method includes acquiring a target object. An annotation for each attribute of the target object is sequentially acquired using a reflection mechanism. The annotation includes a serialization parameter of each attribute. Once each attribute of the target object is converted into first serialized data on a basis of the serialization parameter of the annotation corresponding to the attribute, second serialized data of the target object is generated on a basis of the first serialized data of the attribute.

The present application claims a priority of a Chinese patent application with an application No. 202111656683.2 filed with the China National Intellectual Attribute Administration on Dec. 30, 2021, entire contents of which are incorporated by reference in the present application.

### TECHNICAL FIELD

The present application relates to a technology field of an electronic payment, and in particular relates to a data processing method, an apparatus, an electronic device and a storage medium.

### BACKGROUND

When a POS (point of sales) terminal communicates with a server, exchange data, such as JavaBean objects, is transmitted in a form of data sequences. How to provide a flexible and a scalable method for converting between the exchange data and the data sequences has become a problem that needs to be solved.

### BRIEF DESCRIPTION OF THE DRAWINGS

In order to more clearly illustrate the technical solutions in the embodiments of the present application, the drawings required for use in the embodiments or the description of the prior art will be briefly introduced below. Obviously, the drawings described below are only some embodiments of the present application. For ordinary technicians in this field, other drawings can be obtained based on these drawings without paying any creative labor.

FIG. 1 is a schematic diagram of a communication system provided by an embodiment of the present application;

FIG. 2 is a schematic diagram of a serialization and a deserialization provided by an embodiment of the present application;

FIG. 3 is a schematic diagram of a flow chart of a data processing method provided in an embodiment of the present application;

FIG. 4 is a flow chart of a data processing method provided by another embodiment of the present application;

FIG. 5 is a schematic flow chart of a data processing method provided by another embodiment of the present application;

FIG. 6 is a flow chart of a data processing method provided in an embodiment of the present application;

FIG. 7 is a flow chart of a data processing method provided by another embodiment of the present application;

FIG. 8 is a schematic diagram of a TLV nested data flow provided by an embodiment of the present application;

FIG. 9 is a schematic flow chart of a data processing method provided by another embodiment of the present application;

FIG. 10 is a schematic diagram of a structure of a data processing device provided in an embodiment of the present application;

FIG. 11 is a schematic diagram of a structure of a data processing device provided in an embodiment of the present application;

FIG. 12 is a schematic diagram of a structure of an electronic device provided in an embodiment of the present application.

### EMBODIMENTS OF THE PRESENT APPLICATION

In the following description, specific details such as specific system structures, technologies, etc. are provided for a purpose of illustration rather than a limitation, so as to provide a thorough understanding of embodiments of the present application. However, it should be clear to those skilled in the art that the present application may also be implemented in other embodiments without these specific details. In other cases, detailed descriptions of well-known systems, devices, circuits, and methods are omitted to prevent unnecessary details from obstructing the description of the present application.

It should be understood that when used in the present specification and the appended claims, a term “comprising” indicates a presence of described features, integers, steps, operations, elements and/or components, but does not exclude a presence or an addition of one or more other features, integers, steps, operations, elements, components and/or combinations thereof.

It should also be understood that the term “and/or” used in the present specification and the appended claims refers to any combination and all possible combinations of one or more of the associated listed items, and includes these combinations.

As used in the specification and appended claims of the present application, a term “if” can be interpreted as “when” or “upon” or “in response to determining” or “in response to detecting”, depending on a context. Similarly, a phrase “if it is determined” or “if [a described condition or a described event] is detected” can be interpreted as meaning “upon it is determined” or “in response to determining” or “upon [a described condition or a described event] is detected” or “in response to detecting [a described condition or a described event]”, depending on the context.

In addition, in a description of the present application specification and the appended claims, terms “first”, “second”, “third”, etc. are only used to distinguish descriptions and cannot be understood as indicating or implying relative importance.

References to “one embodiment” or “some embodiments” etc. described in the specification of the present application mean that one or more embodiments of the present application include specific features, structures or characteristics described in conjunction with the embodiment. Therefore, statements “in one embodiment”, “in some embodiments”, “in some other embodiments”, “in other embodiments”, etc. that appear in different places in this specification do not necessarily refer to the same embodiment, but mean “one or more but not all embodiments”, unless otherwise specifically emphasized in other ways. Terms “including”, “comprising”, “having” and their variations all mean “including but not limited to”, unless otherwise specifically emphasized in other ways.

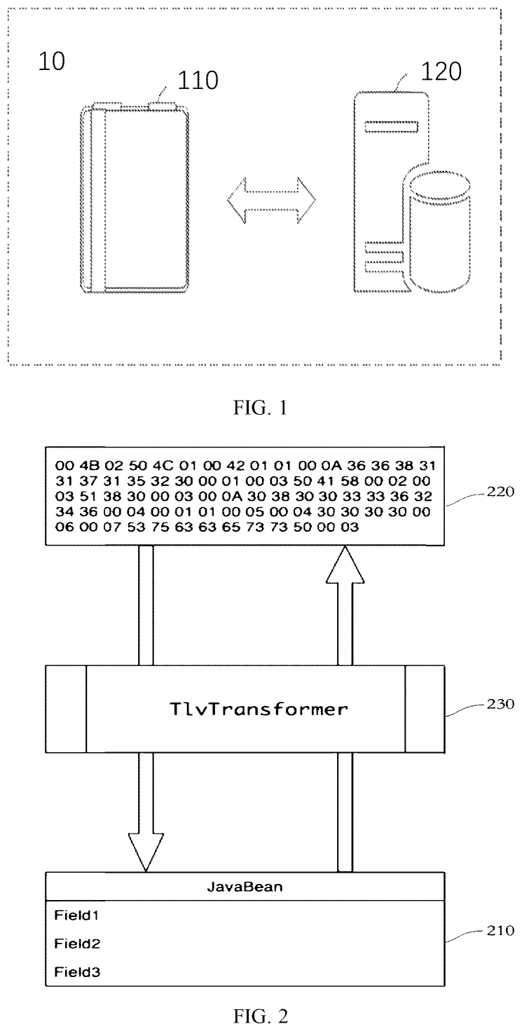

Before explaining a data processing method provided in one embodiment of the present application, in order to facilitate an understanding of the embodiment of the present application, a principle of the data processing method provided in the embodiment of the present application and a related concept involved in the embodiment of the present application are explained in combination with FIG. 1 and FIG. 2 below.

FIG. 1 illustrates a communication system 10 provided in an embodiment of the present application. The communication system 10 includes a terminal device 110 and a server device 120.

In some embodiments, the terminal device 110 may be a POS terminal, and the service device 120 may be a server.

The terminal device 110 and the server device 120 can communicate through a wired and/or wireless communication network. Exchange data needs to be transmitted during a communication between the terminal device and the server device. When exchange data needs to be transmitted between the terminal device and the server device, for example, when sending a request message for a service and receiving and parsing the request message for the service, or when sending a response message and receiving and parsing the response message, an operation of a serialization and an operation of a deserialization needs to be performed on the exchange data to complete the communication.

Taking a Java object as the exchange data as an example, a sender needs to convert the Java object into a byte sequence. After receiving the byte sequence, the receiver converts the byte sequence back to the Java object. The byte sequence is also called serialized data.

Taking a conversion between a JavaBean object and a byte sequence in a TLV (“Tag-Length-Value”) format as an example, see FIG. 2. A Java serialization refers to a process of converting the Java object into the byte sequence in the TLV format. A Java deserialization refers to a process of restoring the byte sequence in the TLV format to the Java object. JavaBeans are some Java classes that are portable, reusable, and can be assembled into applications. The TLV (“Tag-Length-Value”) format is an encoding method. The byte sequence in the TLV format includes three fields: a tag field (tag), a length field (length), and a content field (value).

As shown in FIG. 2, a JavaBean object 210 and a byte sequence 220 in the TLV format are mutually converted through a global data converter (TlvTransformer) 230. The global data converter 230 may be a program running on the terminal device 110 or the server device 120, or may be a processor unit configured on the terminal device 110 or the server device 120 for implementing the serialization and the deserialization.

For a convenience of a description, the terminal device and the server device are collectively called as electronic devices in following embodiments.

In a specific implementation manner of the present application, considering the flexibility and the scalability of a data format when the POS terminal communicates with the server, a TLV (“Tag-Length-Value”) structure can be selected as a carrier for a data interaction between the POS terminal and the server.

To facilitate an understanding of the embodiments of the present application, the following embodiments of the present application are described by taking the exchange data as the JavaBean object and a structure of the serialized data as the TLV structure as an example.

It should be understood that the embodiments of the data processing method, the apparatus, the electronic device, the storage medium, etc. provided in the present application are also applicable to the serialization of the exchange data of a programming language having a reflection mechanism and implementing an annotation function, and are also applicable to a structure of serialized data other than the TLV structure, such as a Varints structure or a ZigZag structure. Under a guidance of the embodiments of the present application, those skilled in the art can migrate the embodiments of the present application to the programming language used by them, or the serialization structure adopted by them without paying a creative labor.

Based on the scenarios described in FIG. 1 and FIG. 2, the applicant of the present application has found that how to provide a flexible and a scalable method for converting between the exchange data and the data sequence has become a problem that needs to be solved. Specifically, in an interaction scenario of exchanging data between the POS terminal and the server, how to convert a byte sequence in the TLV format into a JavaBean object in a simpler, a faster and more universal way, and how to convert a JavaBean object into a byte sequence in the TLV format have become a problem that needs to be solved.

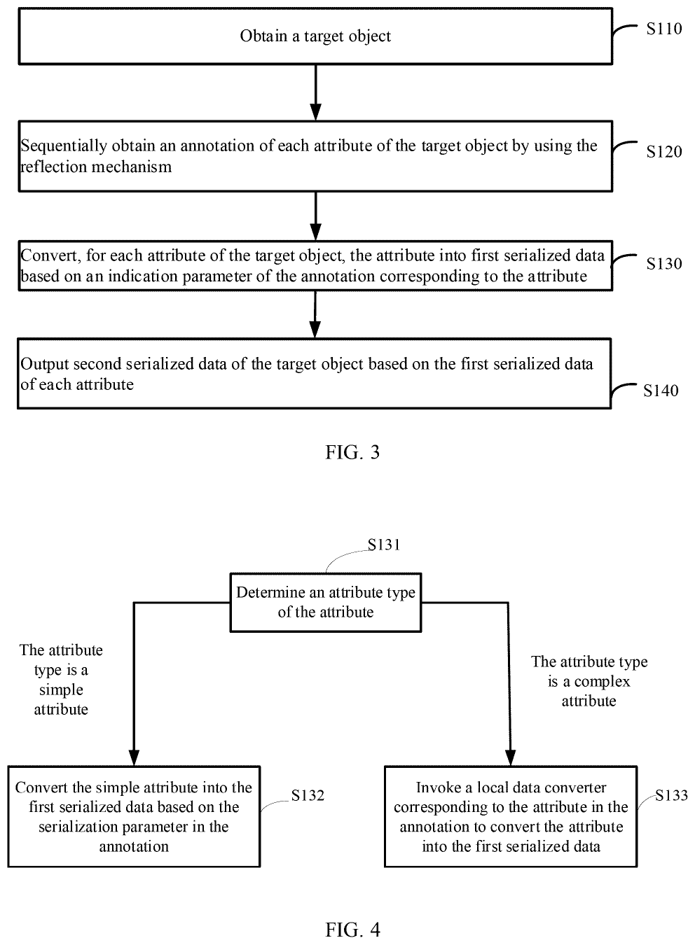

FIG. 3 shows a data processing method provided by an embodiment of the present application, which is applied to the terminal device 110 or the server device 120 in the communication system 10 shown in the FIG. 1, and realizes the conversion of the data object into the serialized data, which can be implemented by a software and/or a hardware of the terminal device 110 or the server device 120. As shown in FIG. 3, the method includes steps S110 to S140. Specific implementation principles of each step are as follows:
S110, a target object is obtained.

In a possible implementation, the electronic device may use the global data converter to implement the serialization. Input data of the global data converter is the target object that is to be serialized, and output data of the global data converter is serialized data corresponding to the target object.

It can be understood that the output data of the global data converter can be an array or a data stream consisting of the serialized data, which can be specifically implemented according to actual business needs.

In a specific example, the electronic device responds to a require message of transmitting the exchange data, invokes the global data converter, and obtains the target object that needs to be serialized. The target object can be an instance of a JavaBean. The global data converter is a program that can perform a conversion of the serialization on the target object, or is a processing unit that implements processing steps provided in the embodiment of the present application.

S120, an annotation of each attribute of the target object is sequentially obtained by using a reflection mechanism; the annotation includes a serialization parameter of a corresponding attribute.

Taking a Java language as an example, a reflection in the Java language is to dynamically obtain information in a class (class information, method information, constructor information, field information, etc.) during a runtime. In other words, the reflection mechanism enables the program to obtain all information of an object during the runtime.

Taking the Java language as an example, the annotations are special “comments” placed before a class, a method, a field, and a parameter of Java source codes. The annotations are directly ignored by a compiler, but the annotations can be packaged into a class file by the compiler. Therefore, the annotation is a kind of “metadata” used for a markup. The annotation is the markup used by the Java language for a tool processing, and the annotation can configure parameters.

After using the annotations to modify members such as the classes, the method, and a variable, these annotations does not take effect on their own. In order to obtain information of the annotations of the class, the method, or the variable, a reflection technology of the Java is used to obtain the annotation object.

In some embodiments, the global data converter of the electronic device uses the reflection mechanism to sequentially obtain annotations of various attributes of the target object.

In a specific example, the global data converter uses a reflection mechanism Field[ ]fields=clazz.getDeclaredFields ( ) for an instance Class clazz=People.class to sequentially obtain the annotation of each attribute of an object clazz.

In the embodiment of the present application, each annotation of the target object is configured with the serialization parameter of the attribute. The serialization parameter is used to indicate a serialization rule of the global data converter or a local data converter.

In some specific embodiments, taking the JavaBean object as the exchange data and taking the structure of the serialized data being the TLV structure as an example, a custom annotation may include TlvField and TlvListField.

The serialization parameter in the custom annotation TlvField can include at least one of following parameters:
a) Tag, a label field in TLV data;
b) Length, a length field in the TLV data;
c) PadChar, padding bytes;
d) LeftPad, whether or not to pad on aleft;
e) DataFormat, a date format of a date type field;
f) Scope: whether to perform the serialization or the deserialization when converting data;
g) Nested, whether it is a complex object;
h) Phase, customizing that whether to perform a business request name of the serialization or deserialization;
i) Handler, customizing a SpringBean of a customized data converter, and realizing an instance of an interface class of the local data converter. Spring bean is an object managed by a Spring framework at runtime.

The serialization parameter in the custom annotation TLIvListFiled can include at least one of following parameters:
a) Tag, the label field in the TLV data;
b) Size, a number of identical TLV data segments;
c) NestObject, a JavaBean type corresponding to a single TLV data segment;
d) Phase, customizing that whether to perform the business request name of the serialization or deserialization;
e) Scope: whether to perform the serialization or deserialization during the data conversion.

In some embodiments, conversion methods of the customized local data converter (TlvTransformHandler) are different based on different data types and business requirements. It is mainly used to convert complex attributes. In a specific example, it has two interfaces:
a) toBytes (object), converting a specified Java object into a byte array;
b) toObject (bytes), converting a specified byte array into a Java object.

The custom annotation TlvField is used to mark basic attributes or complex attributes of the JavaBean, which corresponds to a single TLV data segment. When marking the complex attributes, a data converter interface TlvTransformHandler of a custom layout can be configured to processing a conversion of a complex data format (the data format includes but is not limited to TLV).

The custom annotation TlvListField is used to mark that the attribute of JavaBean corresponds to a set of TLV data segments in the same format.

In some embodiments, the global data converter (TlvTransformer) uses the annotations and the converter defined above to define a complete process of a data conversion to achieve a mutual conversion between JavaBean and TLV data.

In some embodiments, before applying the data processing method provided by the embodiments of the present application, that is, before obtaining the target object, it also includes configuring annotations for the attribute fields of the type (JavaBean).

S130, for each attribute of the target object, the attribute is converted into first serialized data based on the serialization parameter of the annotation corresponding to the attribute.

In some embodiments, the global data converter traverses each attribute of the target object and processes each attribute of the target object.

In a specific example, the serialization parameter include two parameters, the two parameters includes the Tag and Length defined in the above annotation. The global data converter assigns a value to the Tag field of the TL V byte sequence of the attribute according to the Tag, assigns a value to the Length field of the TLV byte sequence of the attribute according to the Length, and serializes the attribute into the byte sequence, that is, the first serialized data, which is stored in the Value field of the TLV sequence of the attribute.

In another specific example, the serialization parameter include the above-mentioned parameters Tag and Handler, among them, the Handler is the local data converter. The local data converter creates the Java object corresponding to different data types and business requirements. A special serialization converter is designed for such Java object. Because it only acts on object attributes in the target object, it can be called the local data converter. The global data converter assigns a value to the Tag field of the TLV sequence of the attribute according to the Tag parameter, and the Handler serializes the object attribute to obtain the first serialized data, which is stored in the Value field of the TLV sequence of the attribute.

An input of the Handler is the attribute of the target object, and the output is the byte sequence corresponding to the attribute, that is, the first serialized data.

In some embodiments, the local data converter may have preset rules for serializing attributes according to different business needs, and the local data converter serializes the attributes according to the rules.

In other embodiments, the attribute of the target object may be an instance of another class, that is, another object. It is understandable that the attribute in the other object may also have annotations. The Handler may perform the conversion of the serialization on the other object according to the annotations in the other object. A principle of the conversion is the same as the principle of the global data converter serializing the target object.

In yet another specific example, the annotation includes at least one of a padding indication parameter PadChar or LeftPad; the method further includes: padding the first serialized data based on the padding indication parameter.

For example, in the annotation @TlvField (tag=0x0011, length=7, padChar=“X”, scope=TlvField. Scope. OUTPUT), the data length is defined as 7, and if it is insufficient, it is padded with a specified character “X”. The length of the serialized byte array of some attribute is fixed, so it needs to be padded if it is insufficient. In the embodiment of the present application, the padding indication parameter is added to the annotation, and when the attribute with the annotation is serialized, it is padded according to the padding indication parameter.

It can also be seen in this example that this annotation includes a serialized switch parameter Scope. The method also includes: determining whether to perform the serialization or the deserialization during the data conversion through the serialized switch parameter. TlvField. Scope. OUTPUT defines through Scope that this attribute is only serialized when it is returned to a invoking end, that is, when the value is OUTPUT. Some attributes only need to be used in business processing, but do not need to be serialized and returned to the invoker, and vice versa. The embodiment of the present application uses the serialized switch parameter to implement whether to perform the serialization or deserialization.

In another specific example, the annotation includes a date format parameter DataFormat; the method further includes, according to the date format parameter, converting a given date string into a date object according to a format. A setting of the date type is set through an attribute, for example, dateFormat=“yyyyMMddHHmmss”.

It can be seen from the above specific examples that the embodiments of the present application can achieve a length padding, a date format setting, and whether to perform the serialization or deserialization during the serialization through the annotation.

S140, second serialized data corresponding to the target object is generated based on the first serialized data of each attribute.

In some embodiments, the global data converter combines the first serialized data of each attribute of the target object according to the preset rule, for example, generate the second serialized data corresponding to the target object by combining according to an order of the attributes. In some specific examples, a process of a combination according to the preset rule may further include encapsulating the first serialized data according to a protocol rule. Specifically, the second serialized data may be a combination of the first serialized data, and a tag field and a length field are added to the first serialized data to form TLV format data, for example, an array of byte sequences in TLV format, or a byte stream of byte sequences in TLV format.

It should be understood that in the embodiment of the present application, the annotation includes the serialization parameter of each attribute of the target object, and uses the reflection mechanism to obtain the annotation of each attribute before serializing the target object, and converts the attribute into the first serialized data based on the serialization parameter of the annotation corresponding to the attribute. The conversion between the target object and the serialized data can be achieved without a need for a third-party dependency library, and because the serialization parameter configured in the annotation can be customized and adjusted, a flexibility of the conversion between the target object and the serialized data is improved.

The specific embodiment of the present application provides a new technical implementation based on the Java Annotation and the reflection mechanism to realize the conversion between the JavaBean and the TLV data format. By configuring Annotation on the field of the attribute of JavaBean, the conversion between the JavaBean and the TLV data format can be realized without using a third-party dependency library, and because the serialization parameter in the annotation can be customized and adjusted, the flexibility of the conversion between the target object and the serialized data is improved.

On the basis of the embodiment of the data processing method shown in FIG. 3, the attributes of the target object are divided into simple attributes and complex attributes.

The simple attributes are attributes defined based on basic data types, including but not limited to an integer data type, a floating-point data type, a character data type, and a string data type defined in a specification of a programming language.

The complex attributes are attributes defined based on customized objects, including but not limited to various attributes defined according to business needs.

Based on this, in step S130, based on the serialization parameter of the annotation corresponding to the attribute, the attribute is converted into the first serialized data, as shown in FIG. 4, steps S131 to S133 are included: S131, an attribute type of the attribute is determined.

In some embodiments, the attribute type of the attribute may be determined based on how the attribute is defined.

In other embodiments, the attribute type of the attribute may be determined according to a type parameter in the annotation.

In some specific examples, the corresponding attribute type can be determined by a name of the annotation, and a parameter identifying the attribute type can be set in the annotation to indicate the attribute type.

In some other specific examples, the attribute type of the attribute may also be determined by determining the type parameter that only the complex attribute has, such as a parameter such as Handler or NestObject.

S132, if the attribute type is the simple attribute, the simple attribute is directly converted into the first serialized data according to the serialization parameter in the annotation.

In some embodiments, if the global data converter determines that the attribute type is the simple attribute, such as the integer data type or the string data type or the other data type defined by a specification of a language, the simple attribute is directly converted into the first serialized data. Specifically, the simple attribute can be directly converted into the first serialized data through a serialization function provided by a programming language, such as Java.

In some specific examples, for the simple attribute, the attribute is determined to be converted into the tag field and the length field of the TLV format according to the parameters “Tag” and “Length” in the annotation.

For example, the annotation @TlvField (tag=0x0088, length=7) of the attribute private String responseCode defines that it is converted into the tag (Tag) “0x0088” and length (Length) “7” of the TLV byte sequence. The global data converter converts the attribute responseCode into a byte sequence of length “7” according to the serialization parameter, and sets the tag field of the TLV structure corresponding to this attribute to “0x0088” according to the value of the “tag” in the annotation.

S133, if the attribute type is the complex attribute, a local data converter corresponding to the attribute in the annotation is invoked to convert the attribute into the first serialized data.

In some embodiments, if the attribute type is the complex attribute, such as a class defined according to a business need, the local data converter corresponding to the attribute in the annotation is invoked to convert the attribute into the first serialized data. A serialization converter for a specific attribute is a local data converter.

In a specific example, an annotation “@TlvField (tag=0x0099, handlerBeanName=“bpsCustomizedAppInfoHandler”)” of a complex attribute “private List<CustomizedApplicationInfo>applicationList” includes the parameter “handlerBeanName=“bpsCustomizedAppInfoHandler””, which is used to instruct the global data converter to invoke the local data converter bpsCustomizedAppInfoHandler to serialize the attribute “applicationList” to obtain the first serialized data.

In another specific example, for an annotation “@TlvListField (tag-0x0077, nestedObject=UpdateFileInfo.class, size=10)” of a complex attribute of a group of data of the same type “private List<UpdateFileInfo>updateFileInfoList”, and the local data converter corresponding to a nested class UpdateFileInfo.class is invoked to perform a conversion of the serialization on the attribute updateFileInfoList to obtain the first serialized data.

It should be noted that when processing the conversion of a data format of the complex attribute, the data format include but is not limited to the TLV format, that is, the local data converter can be used to convert the attribute into the byte sequence of other data format required by a specific business need.

In some embodiments, invoking the serialization converter corresponding to the complex attribute in the annotation to convert the complex attribute into the first serialized data includes: taking the complex attribute as the target object, invoking the local data converter to execute the steps from obtaining the target object to generating the second serialized data of the target object in the method shown in FIG. 3, that is, steps S110 to S140, taking the second serialized data as the first serialized data, and the converter outputting the first serialized data. It can be understood that the embodiments of the present application can not only process the basic attribute and the complex attribute, but also the nested complex attribute.

It is understandable that the present application embodiment can realize the data conversion of the basic attribute defined by the language and the customized complex attributes through the annotation. In addition, a customized local data converter is specified for the complex attributes through the annotation to realize the mutual conversion between JavaBean and other data formats.

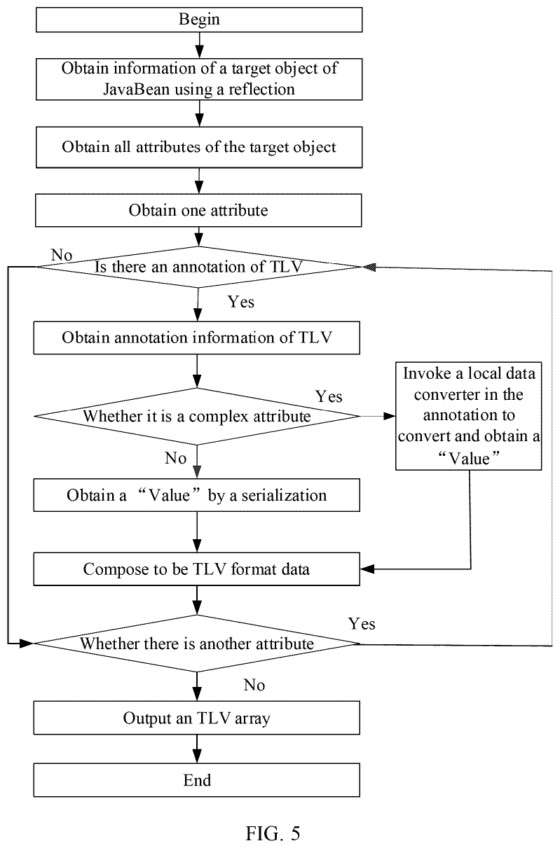

In order to better understand the embodiments of the present application, as an example rather than a limitation, FIG. 5 shows a specific implementation of the present application to facilitate understanding of a deserialized data processing method provided in the embodiments of the present application.

A process of converting a JavaBean object into TLV data includes following steps:
1. Annotations are defined, the annotations are used to mark the attributes of the JavaBean object and corresponding Tag-Length information. If it is a complex object, class information of the complex object is also required.
2. The annotations defined in step 1 are used to mark the attributes of an object to be converted.
3. The global data converter (TlvTransformer) is invoked to convert a specified JavaBean into a TLV byte array.
4. When a JavaBean object is received, TlvTransformer uses a reflection mechanism to sequentially read TLV-related annotation information (if any) of the attributes.
5. For the simple attribute (such as a number, a string, etc.), value information of the TLV byte sequence is obtained by serializing directly. If it is the complex attribute, the corresponding local data converter of the attribute is invoked to convert it into TLV format data or other format data as the Value information.

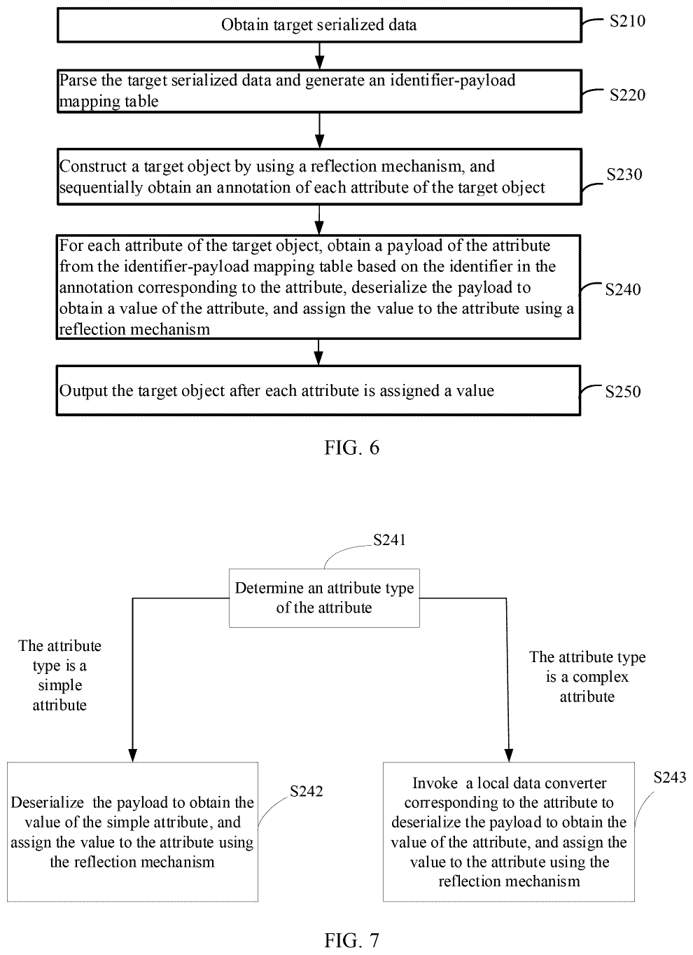

FIG. 6 shows a data processing method provided by an embodiment of the present application, which is applied to the terminal device 110 or the server device 120 in the communication system 10 shown in FIG. 1 above, and realizes the deserialization conversion from the data sequence to the data object, which can be realized by the software and/or hardware of the terminal device 110 or the server device 120. As shown in FIG. 6, the method includes steps S210 to S250. The specific implementation principle of each step is as follows:
S210, target serialized data is obtained.

In a possible implementation, the electronic device can still use the global data converter provided in the above embodiment to implement the deserialization. The input data of the global data converter is the target serialized data to be deserialized, and the output data of the global data converter is the target object corresponding to the target serialized data.

It is understandable that a global data converter may be separately used for implementing the deserialization, and its implementation principle is the same as that of each embodiment of the present application.

In a specific example, in response to a require message of transmitting exchanging data, the electronic device invokes the global data converter to obtain the target serialized data that needs to be deserialized.

The target serialized data can be data with the TLV (“Tag-Length-Value”) structure, or a byte sequence with another structure.

The global data converter is a program that can perform the conversion of the deserialization on the target serialized data, or is a processing unit that implements the processing steps provided in the embodiments of the present application.

S220, the target serialized data is parsed to generate an identifier-payload mapping table; the identifier-payload mapping table includes a corresponding relationship between an identifier of each attribute of the target object and the first serialized data of the attribute; the target object is an object corresponding to the target serialized data.

In some embodiments, the electronic device parses the target serialized data, extracts payload data in the target serialized data, and the identifier corresponding to the payload data, and stores a corresponding relationship between the identifier of the payload and the payload into a payload mapping table. The payload generally refers to pure information of cells of a communication protocol, excluding a header. In an embodiment of the present application, the payload is the first serialized data obtained by converting the attributes of the target object. In the TLV format, the identifier is the value of the “Tag” field, and the payload is the value of the “Value” field.

In some specific examples, the payload mapping table may be a data table consisting of key-value pairs. In some specific examples, the identifier of the payload and the payload are stored in the identifier-payload mapping table in an order of the target serialized data. In another specific example, the identifier of the payload and a pointer of the payload may also be stored in the identifier-payload mapping table.

In a specific example, after receiving a TLV data stream, the electronic device converts the data stream into a TLV container object, which maintains a mapping table of “Tag-Value”. The TLV data format consists of “Tag-Length-Value”, and a mapping relationship between “Tag” and “Value” is obtained by parsing the TLV data. The “Tag” corresponds to the identifier of each attribute of the target object, and the “Value” corresponds to the first serialized data of each attribute.

S230, a target object is constructed using a reflection mechanism, and an annotation of each attribute of the target object is sequentially obtained.

It can be understood that a type of target object may be determined in several different ways.

In some embodiments, the type of the target object may be determined in a pre-specified manner.

In other embodiments, the type of the target object can also be determined by a relevant parameter in a business processing flow, for example, it can be determined based on a type of a received message; for example, it can be determined based on a serialization ID, such as serialVersionUID in Java; for example, the type corresponding to the target serialized data currently required to be parsed can be determined through the business process; for example, it can be determined by type identification information carried in the TLV data stream.

In a specific example, after determining the type of the target object, the global data converter in the electronic device can use the reflection mechanism to construct an instance of the target object, that is, the target object, and sequentially obtain the annotation of each attribute of the target object.

S240, for each attribute of the target object, based on the identifier in the annotation corresponding to the attribute, the payload of the attribute is obtained from the identifier-payload mapping table, the payload is deserialized to obtain the value of the attribute, and a value is assigned to the attribute using the reflection mechanism.

In some embodiments, the identifier in the annotation can be a “Tag” parameter of the above annotation parameter. Since the mapping relationship between “Tag” and “Value” is stored in the identifier-payload mapping table, the global data converter of the electronic device can retrieve the payload of the attribute in the identifier-payload mapping table for each attribute of the target object based on the identifier in the annotation corresponding to the attribute. After obtaining the payload of the attribute, the payload is deserialized to obtain the value of the attribute, and the value is assigned to the attribute using the reflection mechanism.

Corresponding to some specific implementations of the embodiment shown in FIG. 3 above, when the payload is deserialized to obtain the value of the attribute, the payload that has been padded may be de-padded according to the parameter in the annotation. The payload is deserialized according to the date format parameter in the annotation. Whether the payload needs to be deserialized is determined according to the serialized switch parameter.

S250, the target object is output after each attribute is assigned a value.

In some implementations, after each attribute is assigned the value, the global data converter outputs the target object, and completes a deserialization operation of converting the target serialized data into the target object.

It should be understood that in the embodiment shown in FIG. 6, since the target serialized data is parsed in advance, and the identifier-payload mapping table is generated, and the identifier-payload mapping table is used to obtain the payload of the attribute based on the identifier in the annotation, the problem of low operating efficiency caused by repeatedly querying the target serialized data when the program is running is avoided.

Based on the embodiment of the data processing method shown in FIG. 6, the attributes of the target object are divided into simple attributes and complex attributes.

Simple attributes are attributes defined based on basic data types, including but not limited to an integer data type, a floating-point data type, a character data type, and a string data type defined in a specification of a programming language.

Complex attributes are attributes defined based on customized objects, including but not limited to various attributes defined according to business needs.

In step S240, the payload is deserialized to obtain the value of the attribute, and the reflection mechanism is used to assign the value to the attribute, as shown in FIG. 7, steps S241 to S243 are included:

S241, an attribute type of the attribute is determined.

In some embodiments, the attribute type of the attribute may be determined according to a definition of the attribute. In other embodiments, the attribute type of the attribute may be determined according to a type parameter in the annotation.

In some specific examples, the corresponding attribute type can be determined by a name of the annotation, and a parameter identifying the attribute type can be set in the annotation to indicate the attribute type.

In some other specific examples, the attribute type of the attribute may also be determined by determining the type parameter that only the complex attribute has, such as a parameter such as Handler or NestObject.

S242, if the attribute type is the simple attribute, the payload is directly deserialized to obtain the value of the simple attribute, and a value is assigned to the attribute using a reflection mechanism.

In some embodiments, if the global data converter determines that the attribute type is the simple attribute, such as the integer data type or the string data type, or other data types defined by a specification of a language, the payload, such as the “Value” in the TLV format corresponding to the attribute, can be directly deserialized to obtain the value of the attribute.

In some specific examples, a conversion of a deserialization can be directly performed using a deserialization function provided by a programming language such as Java, and the payload is directly deserialized to obtain the value of the simple attribute. After the value of the attribute is obtained, the global data converter uses the reflection mechanism to assign the value to the attribute.

S243, if the attribute type is the complex attribute, a local data converter corresponding to the attribute is invoked to deserialize the payload to obtain the value of the attribute, and the value is assigned to the attribute using the reflection mechanism.

In some embodiments, if the attribute type is the complex attribute, such as an attribute customized by a user according to business needs, the local data converter corresponding to the attribute in the annotation is invoked to deserialize the payload to obtain the value of the attribute. The local data converter is a converter that acts on an attribute.

In some specific examples, the local data converter presets a conversion rule to deserialize the payload to obtain the value of the attribute. In some cases, even if the target serialized data is a TLV byte sequence, the value in the “Value” field can be a non-TLV byte sequence, which can be converted into the attribute of the target object by the local data converter according to the preset rule. It can be understood that, the serialization rules corresponding to different business needs can be customized for the business needs, and the conversion of the serialization and the conversion of the deserialization can be realized by the local data converter according to the preset rule.

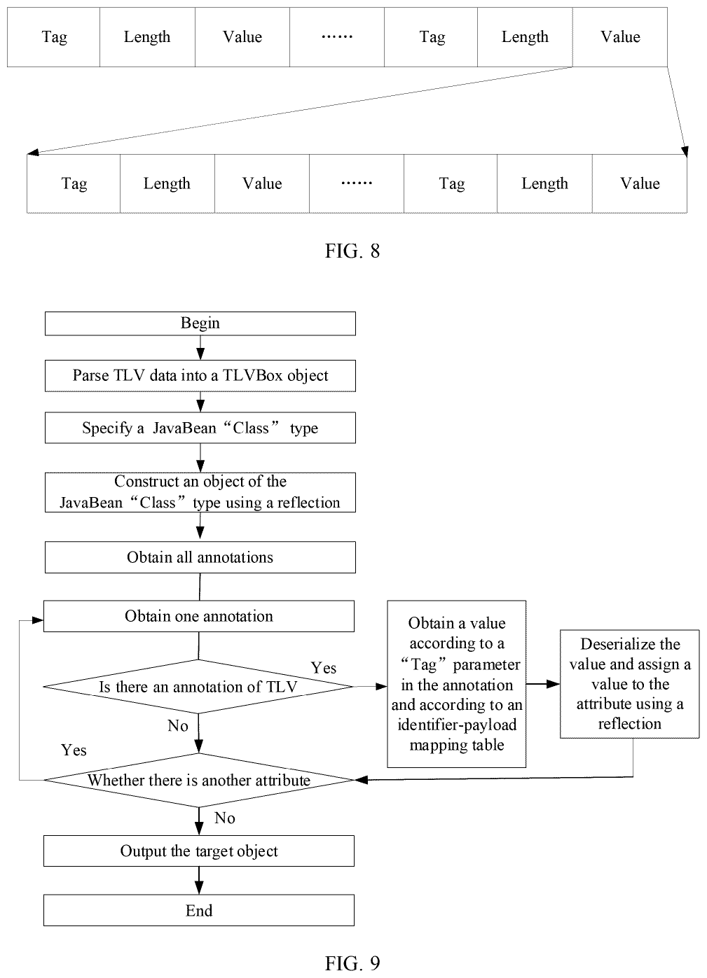

In some embodiments, as shown in FIG. 8, the TLV data stream has a nested structure, also known as a structure of a composite data element. That is, the TLV data includes data of the “Tag” field, the “Length” field and the “Value” field, among them, the serialized data in one or more “Value” fields is itself the serialized data of another object, that is, the TLV data of another object.

For this situation, an embodiment provided by the present application invokes the local data converter corresponding to the attribute, deserializes the payload to obtain the value of the attribute, and uses the reflection mechanism to assign the value to the attribute, including:

The payload is used as the target serialized data, and a deserialization converter executes the method shown in FIG. 6, from the step of obtaining the target serialized data to the step of outputting the target object after each attribute is assigned the value, that is, steps S210 to S250, using the target object as the value of the attribute and assigning the value to the attribute using the reflection mechanism.

It should be understood that this implementation can specify a customized data converter for an attribute JavaBean, can implement a mutual conversion between JavaBean and other data formats, and can also implement a conversion of nested serialized data.

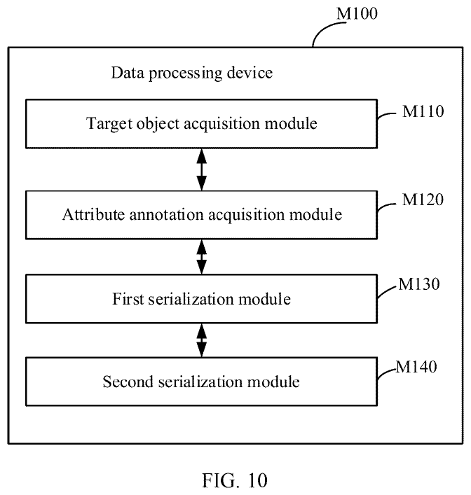

In order to better understand the embodiments of the present application, as an example rather than a limitation, FIG. 9 shows a specific implementation of the present application to facilitate an understanding of a processing method of deserializing data provided in the embodiments of the present application.

A process of converting TLV into JavaBean data:
1. After receiving the TLV data stream, the server converts it into a TLV container (TLVBox) object through a parser. The TLVBox object maintains a mapping table of “Tag-Value”.
2. The global data converter TlvTransformer is invoked to convert the TLV byte sequence data into a JavaBean object of a specified type.
3. According to the specified “Class” type, an instance of the JavaBean is constructed through a reflection technology, and TLV-related annotation information of the attribute (if any) is read sequentially.
4. According to “Tag” information in the Annotation, the corresponding “Value” is obtained from the mapping table of the “Tag-Value” maintained by the TLVBox.
5. For a simple object (such as a number, a string, etc.), it is directly deserialized and is assigned a value to the corresponding attribute using the reflection. For a complex object, the above process 1 to 5 are repeated to complete an instantiation, and a value is assigned to the corresponding attribute using the reflection.
6. After all the attributes marked with TlvField or TlvListField have gone through steps 4 and 5, a JavaBean instance object is output to complete the conversion.

It should be understood that a magnitude of serial numbers of the steps in the above embodiments does not mean an. The order of execution of each process should be determined by its function and internal logic, and should not constitute any limitation on an implementation process of the embodiment of the present application.

Corresponding to the data processing method shown in FIG. 3, FIG. 10 shows a data processing device M100 provided in an embodiment of the present application, including:

A target object acquisition module M110 is used to obtain a target object.

An attribute annotation acquisition module M120 is used to sequentially obtain an annotation of each attribute of the target object by using the reflection mechanism; the annotation includes a serialization parameter of a corresponding attribute to the annotation.

A first serialization module M130 is used to convert, for each attribute of the target object, the attribute into first serialized data based on an indication parameter of the annotation corresponding to the attribute.

A second serialization module M140 is used to generate second serialized data of the target object based on the first serialized data of each attribute.

Optionally, the first serialization module includes: an attribute type determination module, used to determine the attribute type of the attribute. A simple attribute serialization module, used to directly convert a simple attribute into the first serialized data based on a serialization parameter of the annotation in response that the attribute type is the simple attribute. A complex attribute serialization module, used to invoke a serialization converter corresponding to the attribute in the annotation to convert the attribute into the first serialized data in response that the attribute type is a complex attribute. The simple attribute is an attribute defined based on a basic data type, and the complex attribute is an attribute defined based on a customized object.

Optional, the complex attribute serialization module, including:

A complex attribute nested processing module, is used to take the complex attribute as the target object, invoke the module of obtaining the target object to the module of generating the second serialized data of the target object shown in FIG. 9, take the second serialized data as the first serialized data, and the converter outputs the first serialized data.

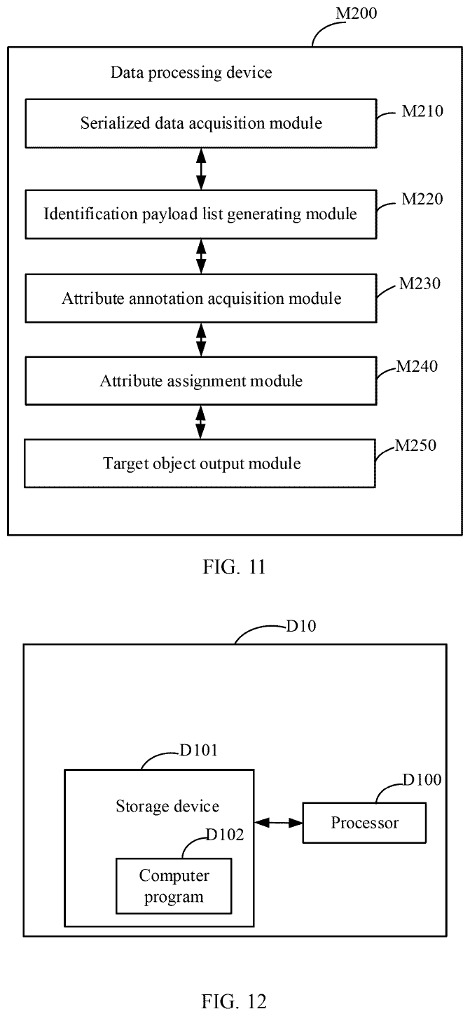

Corresponding to the data processing method shown in FIG. 6, FIG. 11 shows a data processing device M200 provided in an embodiment of the present application, including:

A serialized data acquisition module M210 is used to obtain target serialized data.

An identification payload list generating module M220 is used to parse the target serialized data and generate an identifier-payload mapping table; the identifier-payload mapping table includes a corresponding relationship between an identifier of each attribute of the target object and the first serialized data of the attribute; the target object is an object corresponding to the target serialized data;

An attribute annotation acquisition module M230 is used to construct a target object using a reflection mechanism, and sequentially obtain an annotation of each attribute of the target object;

An attribute assignment module M240 is used to obtain, for each attribute of the target object, the payload of the attribute from the identifier-payload mapping table based on the identifier in the annotation corresponding to the attribute, deserialize the payload to obtain the value of the attribute, and assign the value to the attribute by using the reflection mechanism;

A target object output module M250 is used to output the target object after each attribute is assigned a value.

Optionally, the attribute assignment module includes: an attribute type module, which is used to determine the attribute type of the attribute. A simple attribute deserialization module, which is used to directly deserialize the payload to obtain the value of the simple attribute in response that the attribute type is the simple attribute, and use the reflection mechanism to assign the value to the attribute. A complex attribute deserialization module, which is used to invoke a deserialization converter corresponding to the attribute in response that the attribute type is the complex attribute, deserialize the payload to obtain the value of the attribute, and use the reflection mechanism to assign the value to the attribute. The simple attribute is an attribute defined based on a basic data type, and the complex attribute is an attribute defined based on a customized object.

Optionally, the complex attribute deserialization module comprises: taking the payload as the target serialized data, the deserialization converter implementing the steps in the device described in FIG. 6, from a step of obtaining the target serialized data to a step of outputting the target object after each attribute is assigned the value, taking the target object as the value of the attribute, and assigning the attribute the value using the reflection mechanism.

It can be understood that the various implementation modes and implementation combinations and their beneficial effects in the above embodiments are also applicable to this embodiment and will not be described in detail here.

FIG. 12 is a schematic diagram of a structure of an electronic device provided in an embodiment of the present application. As shown in FIG. 12, an electronic device D10 of this embodiment includes: at least one processor D100 (only one is shown in FIG. 12), a storage device D101, and a computer program D102 stored in the storage device D101 and executable by the at least one processor D100, and the processor D100 implements the steps in any of the above-mentioned method embodiments when executing the computer program D102.

The electronic device D10 may be a computing device such as a POS terminal, a desktop computer, a notebook, a PDA, and a cloud server. The electronic device may include, but is not limited to, a processor D100 and a storage device D101. Those skilled in the art may understand that FIG. 12 is only an example of the electronic device D10 and does not constitute a limitation on the electronic device D10. The electronic device D10 may include more or fewer components than shown in the figure, or may combine certain components, or different components, for example, may also include input and output devices, network access devices, etc.

The processor D100 may be a central processing unit (CPU), or an general-purpose processor, a digital signal processor (DSP), an application-specific integrated circuit (ASIC), a field-programmable gate array (FPGA) or another programmable logic device, a discrete gate or transistor logic device, a discrete hardware component, etc. The general-purpose processor may be a microprocessor or any conventional processor, etc.

In some embodiments, the storage device D101 may be an internal storage unit of the electronic device D10, such as a hard disk or a memory of the electronic device D10. In other embodiments, the storage device D101 may also be an external storage device of the electronic device D10, such as a plug-in hard disk, a smart memory card (SMC), a secure digital (SD) card, a flash card, etc. equipped on the electronic device D10. Further, the storage device D101 may also include both an internal storage unit of the electronic device D10 and an external storage device. The storage device D101 is used to store an operating system, an application program, a BootLoader, data, and other programs, such as the program code of the computer program, etc. The storage device D101 may also be used to temporarily store data that has been output or is to be output.

It should be noted that an information interaction, an execution process, etc. between the above-mentioned devices/units are based on the same concept as the method embodiment of the present application. Their specific functions and technical effects can be found in the method embodiment part and will not be repeated here.

The technicians in the relevant field can clearly understand that for the convenience and simplicity of description, only a division of the above-mentioned functional units and modules is used as an example for illustration. In practical applications, the above-mentioned function allocation can be completed by different functional units and modules as needed, that is, the internal structure of the device can be divided into different functional units or modules to complete all or part of the functions described above. The functional units and modules in the embodiment can be integrated in a processing unit, or each unit can exist physically separately, or two or more units can be integrated in one unit. The above-mentioned integrated unit can be implemented in the form of hardware or in the form of software functional units. In addition, the specific names of the functional units and modules are only for the convenience of distinguishing each other, and are not used to limit the scope of protection of the present application. The specific working process of the units and modules in the above-mentioned system can refer to the corresponding process in the aforementioned method embodiment, which will not be repeated here.

An embodiment of the present application further provides a computer-readable storage medium, among them, the computer-readable storage medium stores a computer program, and when the computer program is executed by a processor, the steps in the above-mentioned method embodiments can be implemented.

An embodiment of the present application further provides a computer program product. When the computer program product runs on an electronic device, the electronic device can implement the steps in the above-mentioned method embodiments when the electronic device is running.

If the integrated unit is implemented in a form of a software functional unit and sold or used as an independent product, it can be stored in a computer-readable storage medium. Based on this understanding, the present application implements all or part of the processes in the above-mentioned embodiment method, which can be completed by instructing the relevant hardware through a computer program. The computer program can be stored in a computer-readable storage medium, and the computer program can implement the steps of the above-mentioned various method embodiments when the computer program is executed by the processor. Among them, the computer program includes computer program codes, and the computer program codes can be in a form of source codes, in a form of object codes, in a form of an executable file or in some intermediate form. The computer-readable medium may at least include: any entity or device that can carry the computer program code to the camera/terminal device, a recording medium, a computer memory, a read-only memory (ROM), a random access memory (RAM), electric carrier signals, telecommunication signals and a software distribution medium. For example, a USB flash drive, a mobile hard disk, a magnetic disk or an optical disk. In some jurisdictions, according to a legislation and a patent practice, the computer-readable medium cannot be electric carrier signals and telecommunication signals.

In the above embodiments, the description of each embodiment has its own emphasis. For parts that are not described or recorded in detail in a certain embodiment, reference can be made to the relevant descriptions of other embodiments.

Those of ordinary skill in the art notes that the units and algorithm steps of each example described in conjunction with the embodiments disclosed herein can be implemented in electronic hardware, or a combination of a computer software and electronic hardware. Whether these functions are performed in hardware or software depends on the specific application and design constraints of the technical solution. Professional and technical personnel can use different methods to implement the described functions for each specific application, but such implementation should not be considered to be beyond the scope of the present application.

In the embodiments provided in the present application, it should be understood that the disclosed devices/network equipment and methods can be implemented in other ways. For example, the device/network equipment embodiments described above are merely schematic. For example, the division of the modules or units is only a logical function division. There may be other division methods in actual implementation, such as multiple units or components can be combined or integrated into another system, or some features can be ignored or not executed. Another point is that a mutual coupling or a direct coupling or a communication connection shown or discussed can be through some interfaces, an indirect coupling or a communication connection of devices or units, which can be electrical, mechanical or other forms.

The units described as separate components may or may not be physically separated, and the components shown as units may or may not be physical units, that is, they may be located in one place or distributed on multiple network units. Some or all of the units may be selected according to actual needs to achieve the purpose of the solution of this embodiment.

The embodiments described above are only used to illustrate the technical solutions of the present application, rather than to limit them. Although the present application has been described in detail with reference to the aforementioned embodiments, a person skilled in the art should understand that the technical solutions described in the aforementioned embodiments may still be modified, or some of the technical features may be replaced by equivalents. Such modifications or replacements do not deviate the essence of the corresponding technical solutions from the spirit and scope of the technical solutions of the embodiments of the present application, and should all be included in the protection scope of the present application.

1. A data processing method, comprising:
obtaining a target object;
sequentially obtaining an annotation of each attribute of the target object by using a reflection mechanism, the annotation comprising a serialization parameter of a corresponding attribute;
for each attribute of the target object, converting the attribute into first serialized data based on the serialization parameter of the attribute;
outputting second serialized data corresponding to the target object based on the first serialized data of each attribute.

2. The method according to claim 1, wherein “converting the attribute into first serialized data based on the serialization parameter of the attribute” comprises:
determining an attribute type of the attribute;
in response that the attribute type is a simple attribute, converting the simple attribute into the first serialized data based on the serialization parameter in the annotation;
in response that the attribute type is a complex attribute, invoking a local data converter corresponding to the attribute in the annotation to convert the attribute into the first serialized data;
the simple attribute being an attribute defined based on a basic data type, and the complex attribute being an attribute defined based on a customized object.

3. The method according to claim 1,
further comprising:
generating the second serialized data corresponding to the target object by combining the first serialized data of each attribute of the target object according to a preset rule.

4. A data processing method, comprising:
obtaining target serialized data;
parsing the target serialized data and generating an identifier-payload mapping table; the identifier-payload mapping table comprising a corresponding relationship between an identifier of each attribute of an object corresponding to the target serialized data and first serialized data of each attribute;
constructing a target object by using a reflection mechanism, and sequentially obtaining an annotation of each attribute of the target object;
for each attribute of the target object, obtaining a payload of the attribute from the identifier-payload mapping table based on the identifier in the annotation corresponding to the attribute, deserializing the payload to obtain a value of the attribute, and assigning the value to the attribute using the reflection mechanism;
outputting the target object after each attribute is assigned a value.

5. The method according to claim 4, wherein “deserializing the payload to obtain a value of the attribute, and assigning the value to the attribute using the reflection mechanism” comprises:
determining an attribute type of the attribute;
in response that the attribute type is a simple attribute, deserializing the payload to obtain a value of the simple attribute, and assigning the value to the attribute using the reflection mechanism;
in response that the attribute type is a complex attribute, invoking a local data converter corresponding to the attribute to deserialize the payload to obtain a value of the attribute, and assigning the value to the attribute using the reflection mechanism;
the simple attribute being an attribute defined based on a basic data type, and the complex attribute being an attribute defined based on a customized object.

6. The method according to claim 4,
further comprising:
determining the attribute type of the attribute according to a definition of the attribute or a type parameter in the annotation.

7-10. (canceled)

11. An electronic device, comprising:
a storage device, being stored with a computer program; and
a processor, wherein when the computer program is executed by the processor, the processor is caused to:
obtain a target object;
sequentially obtain an annotation of each attribute of the target object by using a reflection mechanism, the annotation comprising a serialization parameter of a corresponding attribute;
for each attribute of the target object, convert the attribute into first serialized data based on the serialization parameter of the attribute;
output second serialized data corresponding to the target object based on the first serialized data of each attribute.

12. The electronic device according to claim 11, wherein “convert the attribute into first serialized data based on the serialization parameter of the attribute” comprises:
determining an attribute type of the attribute;
in response that the attribute type is a simple attribute, converting the simple attribute into the first serialized data based on the serialization parameter in the annotation;
in response that the attribute type is a complex attribute, invoking a local data converter corresponding to the attribute in the annotation to convert the attribute into the first serialized data;
the simple attribute being an attribute defined based on a basic data type, and the complex attribute being an attribute defined based on a customized object.

13. The electronic device according to claim 11,
wherein the processor is further caused to:
generate the second serialized data corresponding to the target object by combining the first serialized data of each attribute of the target object according to a preset rule.

14. An electronic device, comprising:
a storage device, being stored with a computer program; and
a processor, wherein when the computer program is executed by the processor, the processor is caused to:
obtain target serialized data;
parse the target serialized data and generate an identifier-payload mapping table; the identifier-payload mapping table comprising a corresponding relationship between an identifier of each attribute of an object corresponding to the target serialized data and first serialized data of each attribute; construct a target object by using a reflection mechanism, and sequentially obtain an annotation of each attribute of the target object;
for each attribute of the target object, obtain a payload of the attribute from the identifier-payload mapping table based on the identifier in the annotation corresponding to the attribute, deserialize the payload to obtain a value of the attribute, and assign the value to the attribute using the reflection mechanism;
output the target object after each attribute is assigned a value.

15. The electronic device according to claim 14, wherein “deserialize the payload to obtain a value of the attribute, and assign the value to the attribute using the reflection mechanism” comprises:
determining an attribute type of the attribute;
in response that the attribute type is a simple attribute, deserializing the payload to obtain a value of the simple attribute, and assigning the value to the attribute using the reflection mechanism;
in response that the attribute type is a complex attribute, invoking a local data converter corresponding to the attribute to deserialize the payload to obtain a value of the attribute, and assigning the value to the attribute using the reflection mechanism;
the simple attribute being an attribute defined based on a basic data type, and the complex attribute being an attribute defined based on a customized object.

16. The electronic device according to claim 14,
wherein the processor is further caused to:
determine the attribute type of the attribute according to a definition of the attribute or a type parameter in the annotation.

17. A non-transitory storage medium having a computer program stored thereon, when the computer program is executed by a processor of an electronic device, the processor is caused to perform a data processing method, wherein the method comprises:
obtaining a target object;
sequentially obtaining an annotation of each attribute of the target object by using a reflection mechanism, the annotation comprising a serialization parameter of a corresponding attribute;
for each attribute of the target object, converting the attribute into first serialized data based on the serialization parameter of the attribute;
outputting second serialized data corresponding to the target object based on the first serialized data of each attribute.

18. The non-transitory storage medium according to claim 17, wherein “converting the attribute into first serialized data based on the serialization parameter of the attribute” comprises:
determining an attribute type of the attribute;
in response that the attribute type is a simple attribute, converting the simple attribute into the first serialized data based on the serialization parameter in the annotation;
in response that the attribute type is a complex attribute, invoking a local data converter corresponding to the attribute in the annotation to convert the attribute into the first serialized data;
the simple attribute being an attribute defined based on a basic data type, and the complex attribute being an attribute defined based on a customized object.

19. The non-transitory storage medium according to claim 17, wherein the method further comprises:
generating the second serialized data corresponding to the target object by combining the first serialized data of each attribute of the target object according to a preset rule.

20. A non-transitory storage medium having a computer program stored thereon, when the computer program is executed by a processor of an electronic device, the processor is caused to perform a data processing method, wherein the method comprises:
obtaining target serialized data;
parsing the target serialized data and generating an identifier-payload mapping table; the identifier-payload mapping table comprising a corresponding relationship between an identifier of each attribute of an object corresponding to the target serialized data and first serialized data of each attribute; constructing a target object by using a reflection mechanism, and sequentially obtaining an annotation of each attribute of the target object;
for each attribute of the target object, obtaining a payload of the attribute from the identifier-payload mapping table based on the identifier in the annotation corresponding to the attribute, deserializing the payload to obtain a value of the attribute, and assigning the value to the attribute using the reflection mechanism;
outputting the target object after each attribute is assigned a value.

21. The non-transitory storage medium according to claim 20, wherein “deserializing the payload to obtain a value of the attribute, and assigning the value to the attribute using the reflection mechanism” comprises:
determining an attribute type of the attribute;
in response that the attribute type is a simple attribute, deserializing the payload to obtain a value of the simple attribute, and assigning the value to the attribute using the reflection mechanism;
in response that the attribute type is a complex attribute, invoking a local data converter corresponding to the attribute to deserialize the payload to obtain a value of the attribute, and assigning the value to the attribute using the reflection mechanism;
the simple attribute being an attribute defined based on a basic data type, and the complex attribute being an attribute defined based on a customized object.

22. The non-transitory storage medium according to claim 21, wherein the method further comprises:
determining the attribute type of the attribute according to a definition of the attribute or a type parameter in the annotation.
